(19) United States
(12) Patent Application Publication
(10) Pub. No.: US 2006/0206859 A1
(43) Pub. Date: Sep. 14, 2006

(54) Method for generating object shapes by emulation

(75) Inventor: Adam Jude Ahne, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/069,074

(22) Filed: Mar. 1, 2005

(51) Int. Cl. G06F 9/44; G06F 9/45

(52) U.S. Cl. 717/105; 717/138

(57) ABSTRACT

A method for generating object shapes by emulation includes executing a software application that facilitates selection of a known media type having at least one predefined object shape; selecting a template corresponding to the known media type, the template including incising coordinates for the at least one predefined object shape; and incising a media sheet based on the selected template.

### BACKGROUND OF THE INVENTION

1. Field of the invention.

The present invention relates to incising devices, such as cutters or perforators, and, more particularly, to a method for generating object shapes by emulation.

2. Description of the related art.

There are a variety of commercially available media types that include predefined object shapes. For example, commercially available media sheet are available that include a plurality of precut adhesive labels at predefined positions on the media sheet. Typically, the commercially available media sheet is inserted into a paper feed slot of an imaging apparatus, such as a printer, and a software application operating in association with a printer driver prints an image, such as text, at the proper locations on the precut media sheet. This assumes, of course, that the user has a readily available supply of the commercially available media sheets.

### SUMMARY OF THE INVENTION

The present invention provides a method for generating object shapes by emulation.

The invention, in one form thereof, is directed to a method for generating object shapes by emulation, including executing a software application that facilitates selection of a known media type having at least one predefined object shape; selecting a template corresponding to the known media type, the template including incising coordinates for the at least one predefined object shape; and incising a media sheet based on the selected template.

The invention, in another form thereof, is directed to a method of emulating a known media type, including identifying each of a plurality of commercially available media types by a media name; storing incising coordinates for each of the plurality of commercially available media types to form a plurality of corresponding incising templates; correlating the media name of each of the plurality of commercially available media types with each of the plurality of corresponding incising templates; facilitating selection of one of the plurality of corresponding incising templates based on identification by media name of a desired media type of the plurality of commercially available media types; and incising a media sheet using the selected template to emulate a corresponding one of the plurality of commercially available media types.

The present invention, in another form thereof, is directed to an apparatus for facilitating the generating of object shapes by emulation. The apparatus includes a user interface including a screen that displays a list of a plurality of available predefined media types, each of the plurality of available predefined media types having at least one predefined object shape, and includes an input device for selecting a predefined media type from the list of the plurality of available predefined media types. A controller is coupled to the user interface. The controller executes program instructions for selecting an incising template corresponding to the predefined media type. The incising template includes incising coordinates for the at least one predefined object shape of the predefined media type that is selected. An incising unit is coupled to the controller. The incising unit incises a media sheet based on the selected incising template.

An advantage of the present invention, for example, is that the user need not have on hand a readily available supply of a commercially available media sheet, such as for example, a sheet of precut labels.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of a system implementing the present invention.

FIG. 2 is a diagrammatic representation of an imaging apparatus configured for use in implementing the present invention.

FIG. 3 is a flowchart depicting a method for generating object shapes by emulation in accordance with the present invention.

FIG. 4 is an illustration depicting a Media Types screen.

FIG. 5 is an illustration depicting a Media Options screen.

Corresponding reference characters indicate corresponding parts throughout the several views. The exemplifications set out herein illustrate one or more embodiments of the invention, and such exemplifications are not to be construed as limiting the scope of the invention in any manner.

### DETAILED DESCRIPTION OF THE INVENTION

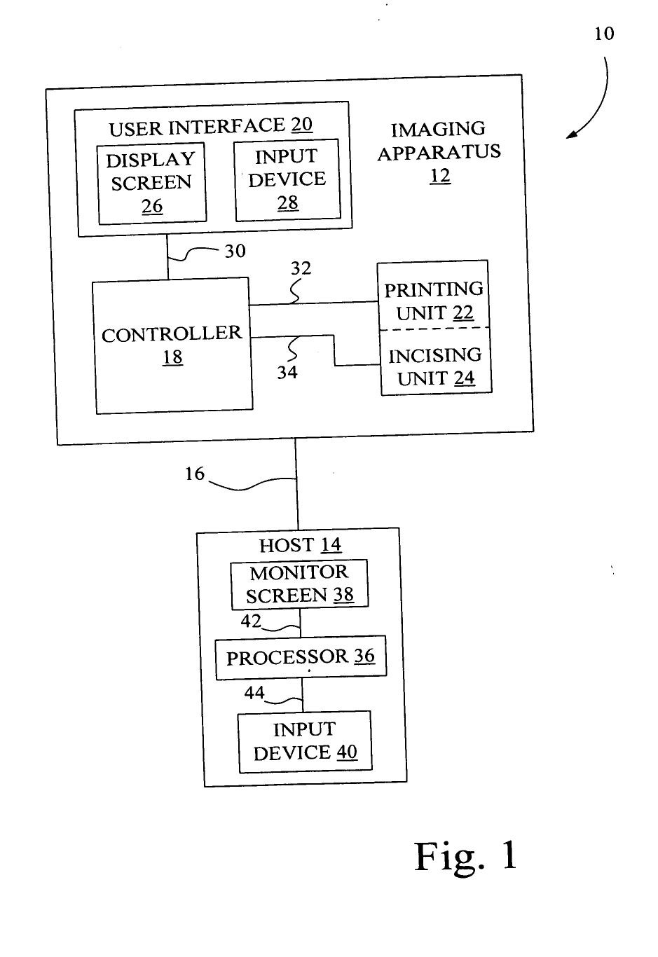

Referring now to the drawings and particularly to FIG. 1, there is shown a system 10 embodying the present invention. System 10 includes an imaging apparatus 12, and optionally, a host 14.

Imaging apparatus 12 may be, for example, a printer, such as an ink jet printer, which in turn may form the print engine for a multi-function device (MFD), such as for example, a standalone unit that has scanning, copying, and/or faxing functionality, in addition to printing functionality. Host 14, which may be optional, may be communicatively coupled to imaging apparatus 12 via a communications link 16.

As used herein, the term “communications link” generally refers to structure that facilitates electronic communication between two components, and may operate using wired or wireless technology. Accordingly, communications link 16 may be, for example, a direct electrical wired connection, a direct wireless connection (e.g., infrared or r.f.), or a network connection (wired or wireless), such as for example, an Ethernet local area network (LAN) or a wireless networking standard, such as IEEE 802.11.

Imaging apparatus 12 includes a controller 18, a user interface 20, a printing unit 22 and an incising unit 24. User interface 20 includes a display screen 26 and an input device 28, such as a keypad. Controller 18 is communicatively coupled to user interface 20 via a communications link 30. Controller 18 is communicatively coupled to printing unit 22 via a communications link 32. Controller 18 is communicatively coupled to incising unit 24 via a communications link 34.

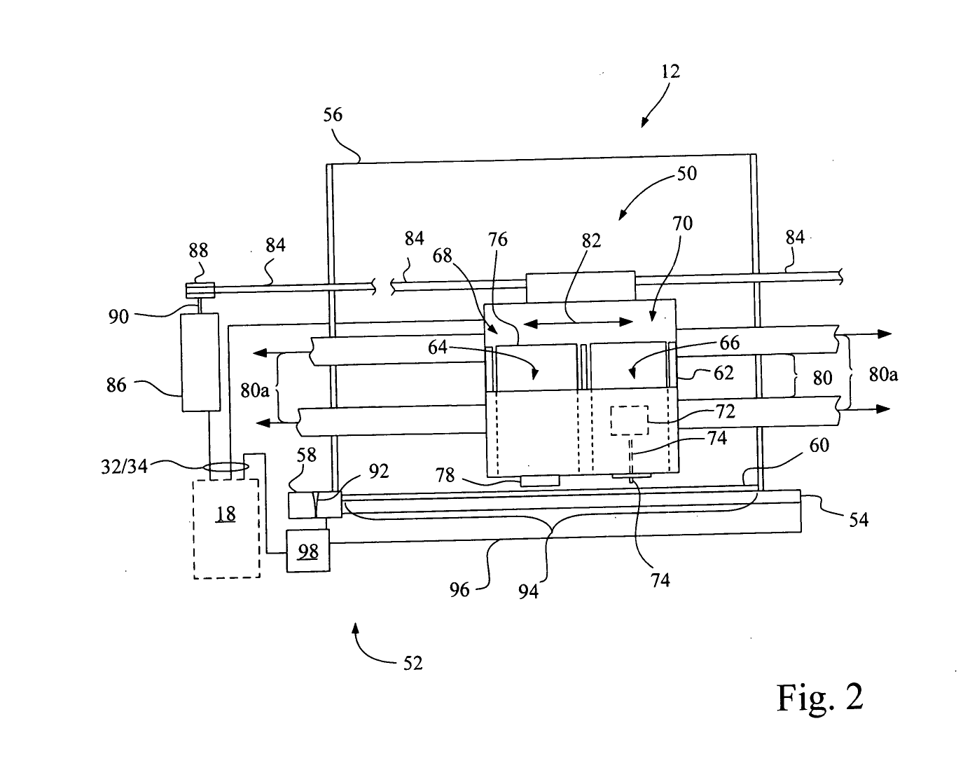

Printing unit 22 may be, for example, an ink jet print engine, or other suitable print engine for forming an imaging on a substrate, such as a sheet of paper, or label stock. Incising unit 24 may include, for example, a perforation device and/or a cutting device. One example of a perforation device, which can also be used for cutting, includes a reciprocating needle assembly, and is described in further detail below with respect to FIG. 2. Known cutting devices include, for example, rotary cutters and knife cutters.

In some embodiments of imaging apparatus 12, such as for example where imaging apparatus 12 is an MFD, controller 18 may include in its memory a software or firmware program including program instructions that function as a driver for printing unit 22 and/or incising unit 24, and will be referred to herein as a driver program. The driver program, for example, may include a halftoning unit and a data formatter subroutine that places print data and print commands in a format that can be recognized by print unit 22, and may include an incising driver subroutine for placing perforation and/or cutting instructions or data in a format that can be recognized by incising unit 24. The driver program may be accessed, for example, by a software application, such as for example, a label making application, a card stock application, etc., that is executing on imaging apparatus 12.

With the present invention, it is advantageous in some embodiments for incising unit 24 to be combined with printing unit 22 in a single imaging apparatus, as shown in FIGS. 1 and 2. However, those skilled in the art will recognize that the principles of the present invention may be achieved in systems where incising unit 24 is independent from printing unit 22.

In embodiments including host 14, host 14 may be, for example, a personal computer including a processor 36, a monitor screen 38 and an input device (e.g., keyboard) 40, and further includes such devices as input/output (I/O) interfaces, memory, such as RAM, ROM, NVRAM, and a mass data storage device, such as a hard drive, CD-ROM and/or DVD units. Processor 36 is communicatively coupled to monitor screen 38 via communications link 42. Processor 36 is communicatively coupled to input device 40 via communications link 44. Further, processor 36 is communicatively coupled to controller 18 of imaging apparatus 12 via communication link 16.

During a printing/incising operation, host 14 may include in its memory the driver program including program instructions that function as a driver for imaging apparatus 12. The driver program, for example, may include a halftoning unit and a data formatter subroutine that places print data and print commands in a format that can be recognized by print unit 22, and may include an incising driver subroutine for placing perforation and/or cutting instructions or data in a format that can be recognized by incising unit 24. The driver program may be accessed, for example, by a software application, such as for example, a word processing application, label making application, a card stock application, etc., that is executing on host 14.

FIG. 2 is one exemplary embodiment of imaging apparatus 12, including printing unit 22 and incising unit 24, that may be used in conjunction with the present invention.

Printing unit 22 and incising unit 24 collectively include, for example, a carrier system 50, a feed roller unit 52, a mid-frame 54, a media source 56, and an incising maintenance station 58.

Media source 56 is configured and arranged to supply from a stack of media a sheet of media 60 to feed roller unit 52, which in turn further transports the sheet of media 60 during a printing operation and/or a perforation operation.

Carrier system 50 includes a carrier 62, i.e., carriage, that is configured with one or more bays, for example bay 64 and bay 66. Each of bays 64, 66 is mechanically and electrically configured to mount, carry and facilitate one or more types of printhead cartridges 68, such as a monochrome printhead cartridge and/or a color printhead cartridge, and/or a perforator cartridge 70 that includes a perforation mechanism 72 driving a perforation device 74, such as a needle or blade, in a reciprocating manner.

Each printhead cartridge 68 includes an ink reservoir 76 provided in fluid communication with a printhead 78, which may include multiple ink jet nozzle arrays. Multiple printheads may be included on printhead cartridge 68. Perforator cartridge 70 is sized and configured to be mechanically and electrically compatible with the configuration of the printhead cartridges 68 so as to be interchangeable therewith in carrier 62 in one of bays 64 and 66.

Carrier 62 is guided by a pair of guide members 80. Either, or both, of guide members 80 may be, for example, a guide rod, or a guide tab formed integral with the imaging apparatus frame. The axes 80a of guide members 80 define a bi-directional scanning path 82 of carrier 62. Carrier 62 is connected to a carrier transport belt 84 that is driven by a carrier motor 86 via a carrier pulley 88. In this manner, carrier motor 86 is drivably coupled to carrier 62 via carrier transport belt 84, although one skilled in the art will recognize that other drive coupling arrangements could be substituted for the example given, such as for example, a worm gear drive. Carrier motor 86 can be, for example, a direct current motor or a stepper motor. Carrier motor 86 has a rotating motor shaft 90 that is attached to carrier pulley 88. Carrier motor 86 is coupled, e.g., electrically connected, to controller 18 via communications link 32.

Incising maintenance station 58 includes an abrasive member 92, such as a ceramic material, arranged to receive and sharpen a perforation device 74, such as for example, a needle or a blade.

At a directive of controller 18, carrier 62 is transported in a controlled manner along bi-directional scanning path 82, via the rotation of carrier pulley 88 imparted by carrier motor 86. During printing, controller 18 controls the movement of carrier 62 so as to cause carrier 62 to move in a controlled reciprocating manner, back and forth along guide members 80. In order to conduct perforator maintenance operations, e.g., sharpening, controller 18 controls the movement of carrier 62 to position carrier 62 in relation to incising maintenance station 58. Printhead 78 is electrically connected to controller 18 via communications link 32. Perforation mechanism 72 is electrically connected to controller 18 via communications link 34.

During a printing/incising operation, the reciprocation of carrier 62 transports printhead 78 and perforation mechanism 72 across the sheet of media 60 along bi-directional scanning path 82, i.e., a scanning direction, to define a print/incising zone 94 of imaging apparatus 12. Bi-directional scanning path 82 is parallel with axes 80a of guide members 80, and is also commonly known as the horizontal direction. Controller 18 supplies electrical address and control signals to the ink jetting actuators of printhead 78 to effect the selective ejection of ink from printhead 78. Further controller 18 supplies control signals to perforation mechanism 72 to effect the selective actuation of perforation mechanism 72 for performing perforating or cutting operations using perforation device 74. During each scan of carrier 62, the sheet of media 60 is held stationary by feed roller unit 52. Feed roller unit 52 includes a feed roller 96 and a drive unit 98. The sheet of media 60 is transported through print/incising zone 94 by the rotation of feed roller 96 of feed roller unit 52. A rotation of feed roller 96 is effected by drive unit 98. Drive unit 98 is electrically connected to controller 18 via communications link 32.

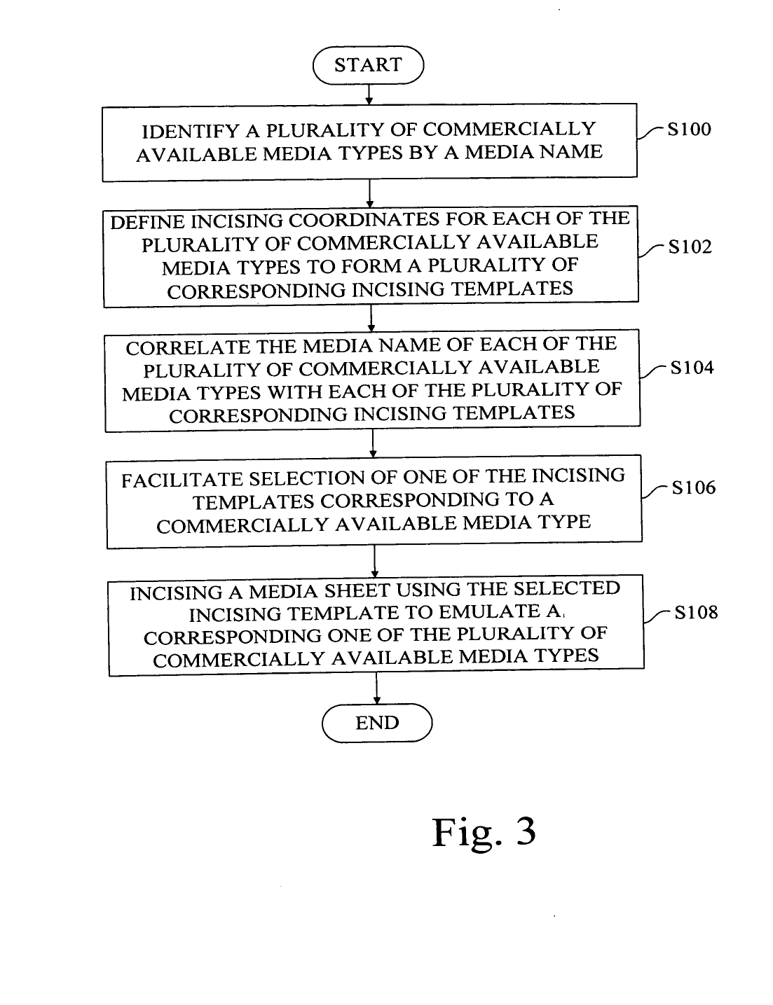

FIG. 3 is a flowchart of an exemplary method, in accordance with the present invention, for generating object shapes by emulation and for emulating a known media type in an imaging system, such as imaging system 10 described above, which includes imaging apparatus 12, and optionally host 14.

The flowchart of FIG. 3 includes steps which are taken to prepare imaging apparatus 12 for use in accordance with the present invention, and may be implemented in the form of a driver program that may be installed, for example, on imaging apparatus 12 and/or host 14. It is contemplated that the driver program may be implemented, for example, in software or firmware. The driver program may be accessed by a software application, such as for example, a word processing application, label making application, a card stock application, etc., that is executing on host 14 and/or imaging apparatus 12.

At step S100, each of a plurality of commercially available media types are identified by a media name. The media types may include, for example, commercially available label stock, or card stock. The label stock may be, for example, a sheet of precut adhesive labels having multiple labels on a sheet. The card stock may be, for example, a sheet of precut, or pre-perforated visitor badges labels or tent cards. The media name may include, for example, a vendor name and/or a vendor part number.

Optionally, custom made media types may be defined and installed in the driver program.

At step S102, incising coordinates for each of the plurality of commercially available media types are defined to form a plurality of corresponding incising templates. The incising templates are stored in memory that is accessible to the driver program. In other words, for each commercially available media type identified in step S100 there will be a corresponding template in the driver program that includes the incising coordinates used to form the perforations or cuts on a blank media stock to emulate the commercially available media stock. The blank media stock may be, for example, an uncut adhesive label sheet or uncut/non-perforated card stock.

At step S104, the media name of each of the plurality of commercially available media types identified in step S100 is correlated with each of the plurality of corresponding incising templates. Such a correlation may be implemented, for example, as a lookup table in the program driver.

At step S106, an interface is defined in the driver program to facilitate selection of one of the incising templates corresponding to one of the commercially available media types. The selection is based on an identification of the appropriate incising template, by the predefined media name, that corresponds to the desired media type of the plurality of commercially available media types.

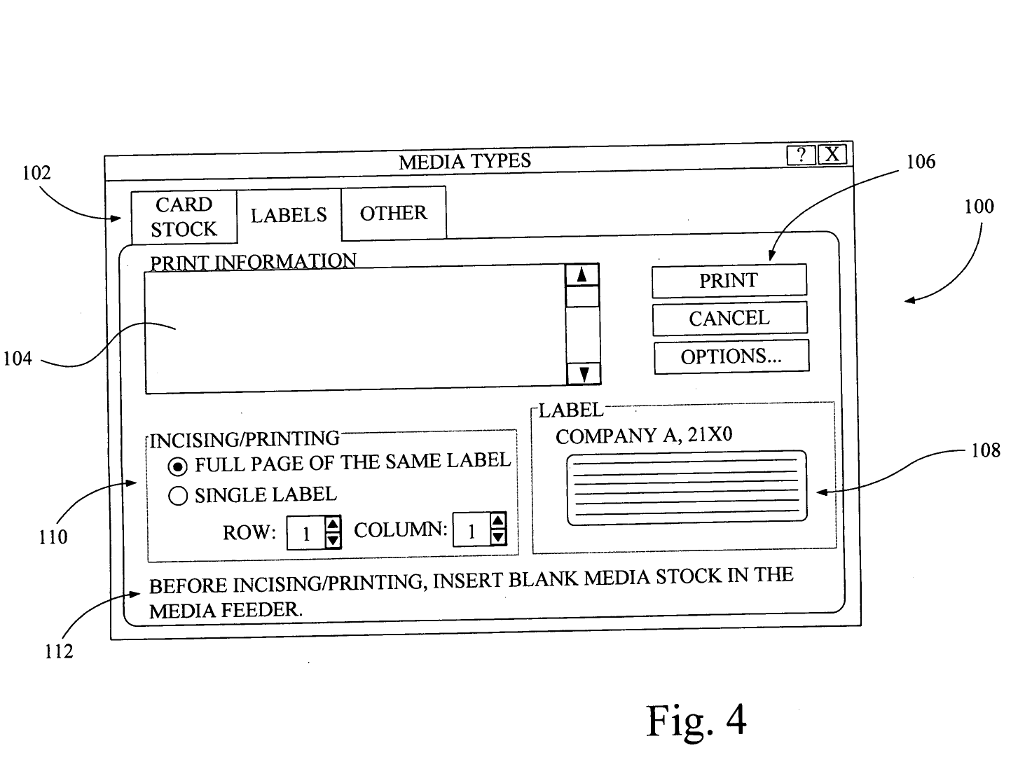

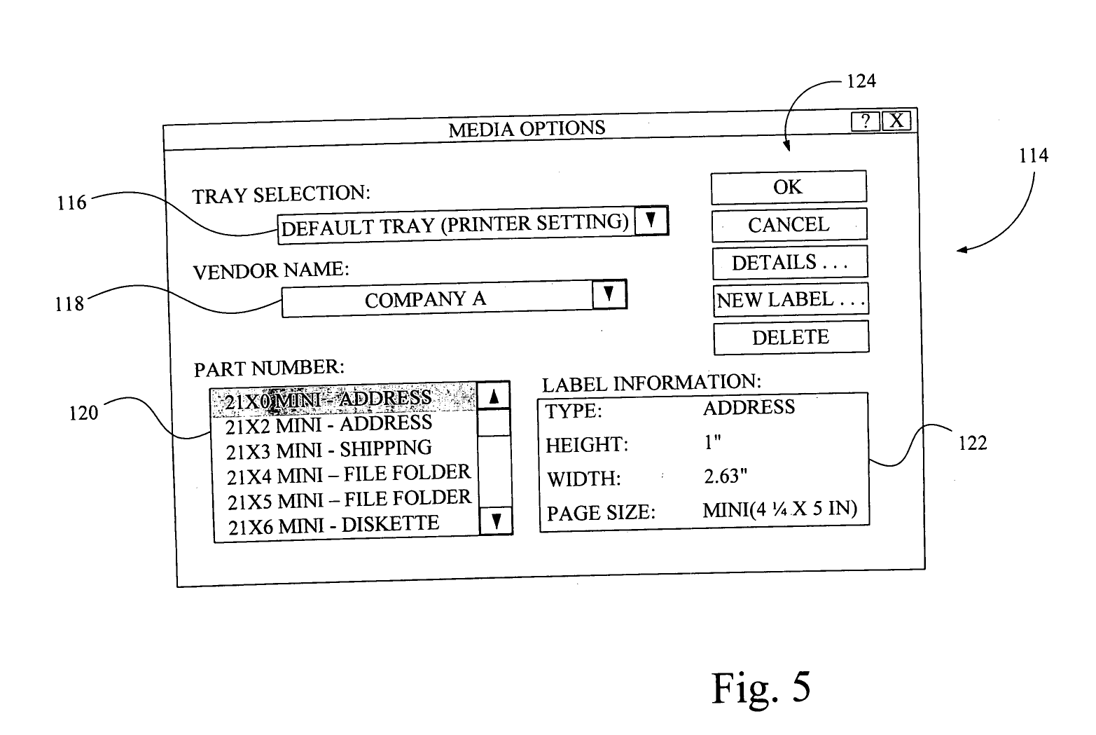

The interface defined in the driver program generates a user screen that may be displayed, for example, on display screen 26 of imaging apparatus 12 and/or monitor screen 38 of host 14. FIGS. 4 and 5 are exemplary screens of such an interface, and will be described in more detail below.

At step S108, based on the selection made, the incising coordinates are supplied to incising unit 24, and print data (if any) is supplied to printing unit 22. Imaging apparatus 12 then performs incising of a media sheet, e.g., blank stock, using the selected template to emulate a corresponding one of the plurality of commercially available media types, or alternatively, a custom media type, and also performs any desired printing in conjunction with the incising. The incising may be, for example, perforations and/or cuts.

FIG. 4 is an exemplary Media Type main screen 100 that includes tabs 102 for Labels, Card Stock, and Other. Templates corresponding to commercially available label stock, for example, will be accessed via the Label tab. Templates corresponding to commercially available card stock, for example, will be accessed via the Card Stock tab. Custom templates, for example, may be accessed through the Other tab. Print information to be printed on the selected media type, if any, may be displayed in a data entry window 104.

On the right side of Media Type screen 100 is a column of user selectable buttons 106, such as for example, Print, Cancel, and Options. A preview 108 of the media type, identified for example by vendor name (e.g., Company A) and vendor part number (e.g., 21x0) is displayed in the lower right corner of Media Type screen 100. That which is displayed in preview 108 is dependent on the media type selected, which is performed as illustrated in the Media Options screen 114 shown in FIG. 5, which may be accessed via the Options button. On the lower left side of Media Type screen 100 is an incising/printing option 110, which, in this example, permits the selection of a full page of labels or a single label. At the bottom of Media Type screen 100 is an instruction line 112 informing the user to insert blank media stock in the media feeder of imaging apparatus 12 before incising/printing.

The features described above with respect to Media Type screen 100 are strictly exemplary. In addition to the features described above, those skilled in art will recognize that other features may be added to Media Type screen 100 to accommodate additional options, if desired.

Activating the Options button of Media Type screen 100 causes the driver program to display a Media Type sub-screen, identified as a Media Options screen 114 in FIG. 5.

The Media Options screen 114 includes, for example, a window 116 for selecting a media tray in imaging apparatus 12 to be used, a window 118 for selecting the vendor by name, and a window 120 for selecting by vendor part number of a particular media type associated with the selected vendor. In this example, a window 122 displays label information associated with the particular media type selected. Along the right side of screen 114 is a group of user convenience buttons 124, including OK, Cancel, New Label, and Delete.

The features described above with respect to Media Options screen 114 are strictly exemplary. In addition to the features described above, those skilled in art will recognize that other features may be added to Media Options screen 114 to accommodate additional options, if desired.

While this invention has been described with respect to exemplary embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for generating object shapes by emulation, comprising:
executing a software application that facilitates selection of a known media type having at least one predefined object shape;
selecting a template corresponding to said known media type, said template including incising coordinates for said at least one predefined object shape; and
incising a media sheet based on the selected template.

2. The method of claim 1, wherein said know media type is a commercially available media.

3. The method of claim 2, wherein said selecting is performed by associating at least one of a vendor name and a vendor part number of said known media type with said template.

4. The method of claim 3, further comprising performing a printing operation in conjunction with said incising.

5. The method of claim 1, wherein said know media type is a custom media.

6. The method of claim 1, wherein said incising is performed by one of cutting and perforating.

7. The method of claim 1, further comprising performing a printing operation in conjunction with said incising.

8. The method of claim 1, wherein said software application is running on one of a host and an imaging apparatus.

9. The method of claim 1, wherein said incising is performed by an imaging apparatus including a printing unit and an incising unit, said incising unit being configured to perform at least one of perforating and cutting.

10. A method of emulating a known media type, comprising:
identifying each of a plurality of commercially available media types by a media name;
defining incising coordinates for each of said plurality of commercially available media types to form a plurality of corresponding incising templates;
correlating said media name of each of said plurality of commercially available media types with each of said plurality of corresponding incising templates;
facilitating selection of one of said plurality of corresponding incising templates based on identification by media name of a desired media type of said plurality of commercially available media types; and
incising a media sheet using the selected template to emulate a corresponding one of said plurality of commercially available media types.

11. The method of claim 10, wherein said media name is at least one of a vendor name and a vendor part number.

12. The method of claim 11, further comprising performing a printing operation in conjunction with said incising.

13. The method of claim 10, wherein said incising is performed by one of cutting and perforating.

14. The method of claim 10, further comprising performing a printing operation in conjunction with said incising.

15. An apparatus for facilitating the generating of object shapes by emulation, comprising:
a user interface including a screen that displays a list of a plurality of available predefined media types, each of said plurality of available predefined media types having at least one predefined object shape, and an input device for selecting a predefined media type from said list of said plurality of available predefined media types;
a controller coupled to said user interface, said controller executing program instructions for selecting an incising template corresponding to said predefined media type, said incising template including incising coordinates for said at least one predefined object shape of said predefined media type that is selected; and
an incising unit coupled to said controller, said incising unit incising a media sheet based on the selected incising template.

16. The apparatus of claim 15, further comprising a printing unit for performing a printing operation in conjunction with said incising.

17. The apparatus of claim 15, wherein at least one of said plurality of available predefined media types is a commercially available media.

18. The apparatus of claim 15, wherein at least one of said plurality of available predefined media types is a custom media.

19. The apparatus of claim 15, wherein said incising is performed by one of cutting and a perforating.
